(19) United States
(12) Patent Application Publication
(10) Pub. No.: US 2011/0179919 A1
(43) Pub. Date: Jul. 28, 2011

(54) TOOL FOR HANDS FREE PATTERN CREATING DEVICE

(75) Inventors: Dan Nelson, Bountiful, UT (US); Josh Malone, Plano, TX (US)

(73) Assignee: MAKING MEMORIES, Centerville, UT (US)

(21) Appl. No.: 12/844,689

(22) Filed: Jul. 27, 2010

Related U.S. Application Data
(60) Provisional application No. 61/228,900, filed on Jul. 27, 2009.

(51) Int. Cl. B26D 1/00; B43K 29/00; B26D 5/00

(52) U.S. Cl. 83/13; 401/193; 83/72

(57) ABSTRACT

A pattern creating implement may include a pattern creating tip on a first end, a connection member on a second end, and an engagement member between the first and second ends. The engagement member may be configured to be engaged by an implement placement member for detachably coupling the connection member to an implement receptor of a pattern creating device. According to various embodiments, a pattern creating device controls the rotational, vertical and planar movements of the pattern creating tip to transfer a digital pattern to a media. A tool may be configured to receive, resupply, and/or insert a pattern creating implement. According to one embodiment, in conjunction with an optional cap, a body of a tool may be configured to house a pattern creating implement when it is not in use.

### RELATED APPLICATIONS

This application claims the benefit of U.S. Provisional Patent Application No. 61/228,900 filed on Jul. 27, 2009, titled Illustrator Apparatus for Hands Free Pattern Creating Device, the entirety of which is incorporated herein by reference.

### TECHNICAL FIELD

The disclosure generally relates to an automatic pattern creating device and a tool including a pattern creating implement. Specifically, a pattern creating device may be configured to transfer a digital pattern to a media via a pattern creating implement.

### BRIEF DESCRIPTION OF THE DRAWINGS

FIG. 1 is a perspective view of an exemplary tool.

FIG. 2 is a component view of an exemplary tool.

FIG. 3A illustrates a perspective view of a tool coupling a pattern creating implement to an implement receptor of a pattern creating device, according to one embodiment.

FIG. 3B illustrates perspective view of a pattern creating implement coupled to an implement receptor with a body of a tool engaged to a pattern creating implement, according to one embodiment.

FIG. 3C illustrates perspective view of a pattern creating implement coupled to an implement receptor of a pattern creating device with a body of a tool disengaged, according to one embodiment.

FIG. 4 illustrates an exemplary pattern creating device and a butterfly drawn on a media disposed on a secondary mat.

FIG. 5A illustrates a implement removal tool disposed on a cap of a tool prior to removing a pattern creating implement, according to one embodiment.

FIG. 5B illustrates a implement removal tool removing a pattern creating implement from an implement receptor of a pattern creating device, according to one embodiment.

FIG. 5C illustrates a removed pattern creating implement, an illustrator device with a cap including an implement removal tool, and an illustrator device with an empty implement receptor, according to one embodiment.

FIG. 6 is an exemplary cross-sectional view of a tool.

FIG. 7A illustrates an exemplary pattern creating implement, including a pattern creating tip, an engagement member, and a connection member.

FIG. 7B is an exemplary cross-sectional view of a pattern creating implement including a marking tip.

FIG. 7C is a top view of the exemplary marking tip of FIG. 7A.

FIG. 8 illustrates an exemplary method for transferring a digital pattern to a media using a tool and a pattern creating device.

In the following description, numerous specific details are provided for a thorough understanding of the various embodiments disclosed herein. The systems and methods disclosed herein can be practiced without one or more of the specific details, or with other methods, components, materials, etc. In addition, in some cases, well-known structures, materials, or operations may not be shown or described in detail in order to avoid obscuring aspects of the disclosure. Furthermore, the described features, structures, or characteristics may be combined in any suitable manner in one or more alternative embodiments.

### DETAILED DESCRIPTION

A pattern creating implement is connected to and controlled by a pattern creating device to transfer a digitally stored pattern to a suitable media, such as paper, cloth, foil, cardstock, plastic, leather, and the like. Patterns are transferred to a media by a pattern creating tip of a pattern creating implement. For example, pattern creating tips include marking tips, cutting tips, glue tips, embossing tips, debossing tips, spray nozzles, paint tips, glitter applicators, fondant cutting tips, chalk tips, and other applicators or dispensers for embellishing a media. Examples of pattern creating devices and associated implements are provided in U.S. patent application Ser. No. 12/576,506 filed on Oct. 9, 2009, titled Hands Free Pattern Creating Device, which is incorporated herein by reference in its entirety.

According to various embodiments, pattern creating implements are configured for interchangeable use with various pattern creating devices. Accordingly, pattern creating implements, each of which may be configured to transfer a pattern using a different medium (e.g., chalk, paint, or marker), may be interchangeably used with a self-contained, portable handheld pattern creating device. Furthermore, a digital pattern cutting mechanism may be adapted for use as a pattern creating device by removing the cutting tip and replacing it with a pattern creating tip.

According to several embodiments, a user accesses a graphical user interface associated with a pattern creating device and selects a digital pattern to be transferred to a media, such as paper. A pattern creating implement is inserted in an implement receptor of a pattern creating device. The user then positions the pattern creating device at a desired position on the paper. According to some embodiments a secondary mat is positioned beneath the paper. Once the pattern creating device is in the desired position on the paper, the user initiates the automated pattern transfer process. During the automated pattern transfer process, a user may manually secure the pattern creating device relative to the paper. Alternatively, the pattern creating device may be configured for hands-free use. For example, the pattern creating device may utilize magnets, levers, clamps, suction cups, locks, or a combination thereof to secure the pattern creating device relative to the paper.

According to various embodiments, pattern creating implements of various sizes, shapes, and mediums (e.g., chalk or marker) are configured for use with any of a variety of media such as paper, corkboard, leather, metal, stone or other surfaces on which or from which a pattern can be formed.

A pattern creating implement may be configured to have any shape or size to suit a particular application or for use with any number of pattern creating devices. A pattern creating implement includes a first end and a second end. The first end may include a pattern creating tip for transferring a pattern to a media. The second end may include a connection member useful for detachably securing a pattern creating implement to an implement receptor of a pattern creating device. The connection member of the pattern creating implement and the implement receptor of the pattern creating device may be coupled using threads, twist lock members, grooves, protrusions, snap-on elements, friction-fit components, or other suitable connection elements. The pattern creating implement may further include an engagement member disposed between the first and second ends useful for coupling and decoupling the connection member from an implement receptor.

According to various embodiments a pattern creating implement is one component of a tool comprising a body, the pattern creating implement, and a cap. Accordingly, the pattern creating implement may be inserted at least partially within a body for storage and/or resupply. A cap may be coupled to the body such that the pattern creating tip is protected or sealed within the body and cap. According to various embodiments, the body and cap prevent the pattern creating implement from drying out (such as in the case of paint or marker). Furthermore, according to several embodiments, the body contains a reservoir or supply of a particular medium. By inserting the pattern creating tip of a pattern creating implement into a body containing a reservoir, the pattern creating tip is replenished. A cap may be coupled to the body to further encompass or protect the pattern creating implement. According to various embodiments, the body and/or cap include implement replacement and/or removal tools for detachably securing or removing a pattern creating implement from an implement receptor of a pattern creating device. Thus, according to various embodiments, a tool may house any of a variety of pattern creating implements, some of which include bodies configured to replenish a marking medium in a pattern creating tip. Moreover, the body and/or cap may allow easy insertion and removal of pattern creating implements from pattern creating devices.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, an “embodiment” may be a system, a method, or a product of a process.

As used herein, the term “media” signifies any type of material on which or from which a pattern may be made. Types of media include, but are not limited to, paper, corkboard, leather, metal, stone, wood, canvas, cardstock, cardboard, and edible foods such as cakes and cookies, and fondant. As used herein, the term “decoration” or “decorative material” as used throughout the specification and claims refers to any substance that may be used for decorating, embellishing, or otherwise creating a pattern in or on a media. Examples of decorative materials include inks, gels, graphite, chalks, clay, other pigments, glue, glitters, metallic inlays, fluids (e.g., paints and edible icings), gels, lacquers, embellishing liquids, glosses, and the like. Additionally, decorations may include embossing, debossing, and cutting.

In the following description, numerous details are provided to give a thorough understanding of various embodiments. The embodiments disclosed herein can be practiced without one or more of the specific details, or with other methods, components, materials, etc. In other instances, well-known structures, materials, or operations are not shown or described in detail to avoid obscuring aspects of this disclosure.

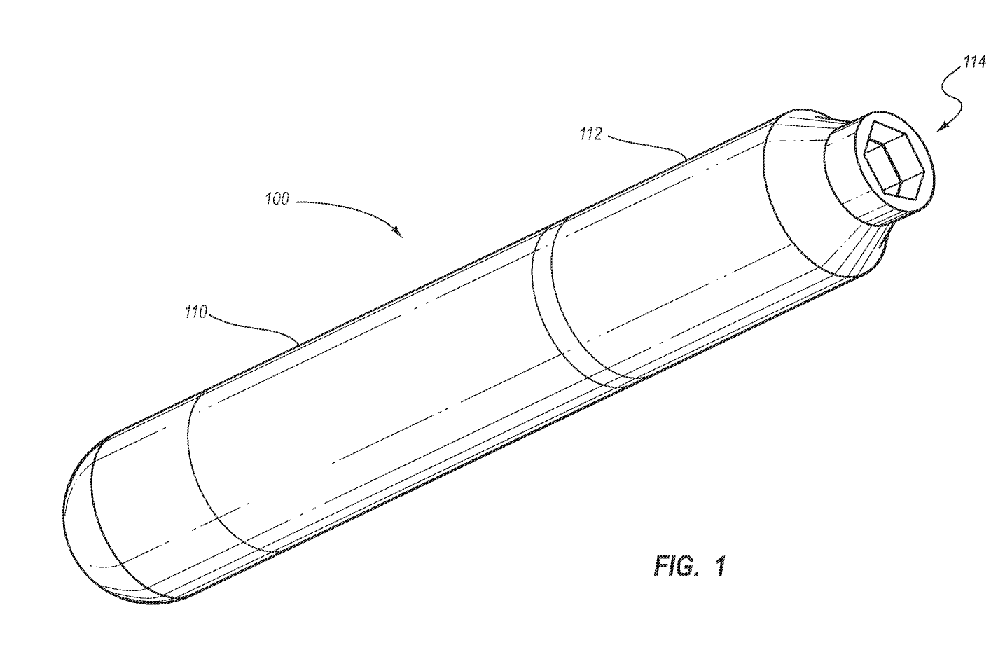

As illustrated in FIG. 1, an exemplary tool 100 includes a body 110, a cap 112, and an implement removal tool 114. Cap 112 is configured to mate with body 110 and enclose a pattern creating implement (not illustrated) therein. The end of cap 112 includes an implement removal tool 114 useful for removing a pattern creating implement from a pattern creating device. The dimensions and specific configuration of tool 100 may be adapted to suit any of a variety of applications. For example, as is described in more detail below, body 110 may house a felt inkwell or other decorative material reservoir. The decorative material reservoir within body 110 may be configured so as to resupply a pattern creating implement. Cap 112 may be configured to ensure that an enclosed pattern creating implement is in continuous contact with the decorative material reservoir during resupply and storage.

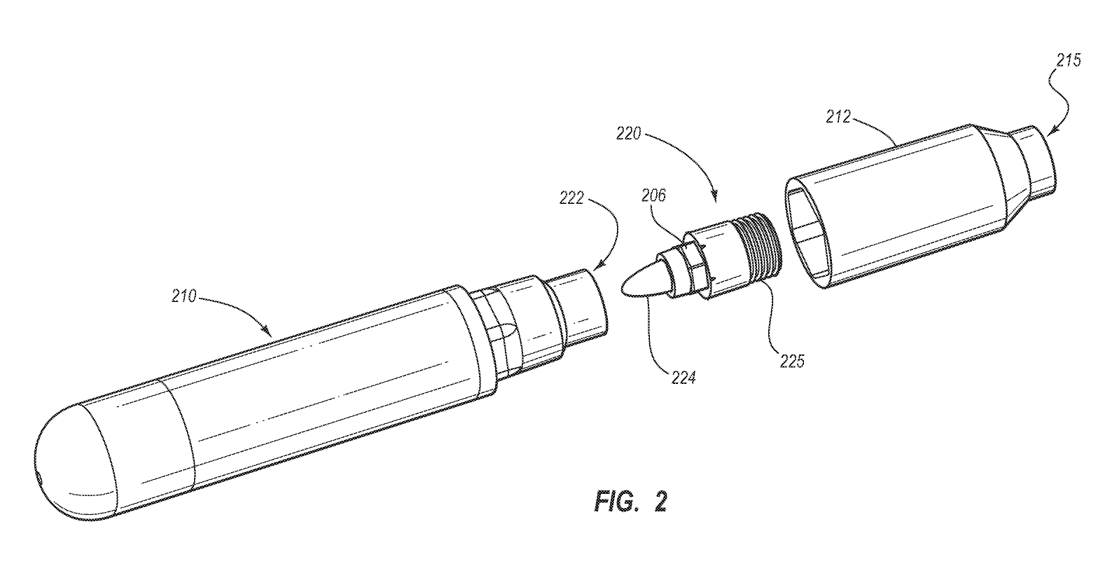

FIG. 2 illustrates a component view of a tool including a body 210, a pattern creating implement, and a cap 212. Pattern creating implement 220 includes a pattern creating tip 224 adapted for transferring a pattern from a pattern creating device to a media, an engagement member 206, and a connection member 225. Body 210 includes an implement placement member 222 configured to receive pattern creating implement 220. Implement placement member 222 is configured to engage engagement member 206 during the insertion of connection member 222 into an implement receptor of a pattern creating device (not shown). Pattern creating tip 224 may be configured to transfer any number of patterns to a medium of any suitable shape or size using a variety of decorations. For example, pattern creating tip 224 may include a marking tip, cutting tip, gluing tip, embossing tip, spray nozzle, or the like.

In the illustrated embodiment, pattern creating tip 224 is illustrated as a marking tip and functions similar to a traditional marker in that it retains a marking decorative material and when pressed against a media transfers ink to the media. As illustrated, pattern creating tip 224 may be removed from body 210 and cap 212. According to one embodiment, when a user removes cap 212, pattern creating tip 224 remains secured in body 210 by implement placement member 222. Implement placement member 222 may be formed in a shape that is complementary to the shape of engagement member 206. In the illustrated embodiment, for example, implement placement member 222 is a female polygonal shape corresponding to a male polygonal shaped engagement member 206 on pattern creating implement 220. Implement placement member 222 may engage engagement member 206, and accordingly implement placement member 222 may be used to hold pattern creating implement 220 while connection member 225 in threaded into an implement receptor (not shown) of a pattern creating device (not shown).

Various embodiments may also include an implement removal tool 215 coupled to cap 212. Similar to implement placement member 222, implement removal tool 215 may be formed in a shape that is complimentary to the shape of engagement member 206. FIG. 2 illustrates a hexagonal shape; however, a wide variety of shapes are contemplated, such as a keyed circular shape, a rectangular shape, a triangular shape, a square shape, a pentagonal shape, etc. As noted above, the embodiment illustrated in FIG. 2 includes a hexagonal shaped engagement member 206. The implement removal tool 215 may be used to hold pattern creating implement 220 while connection member 225 is threaded into an implement receptor.

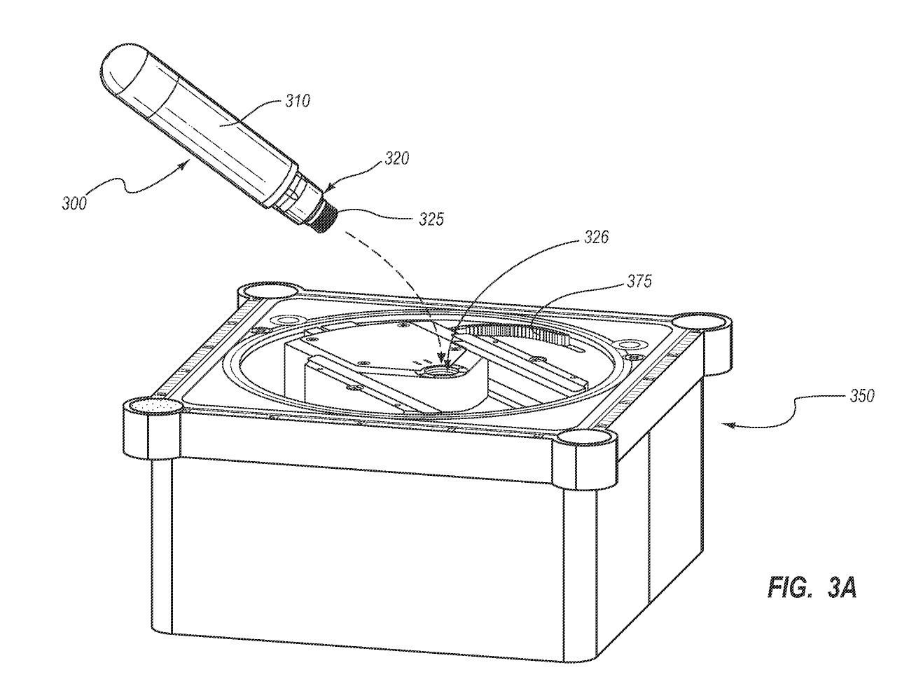

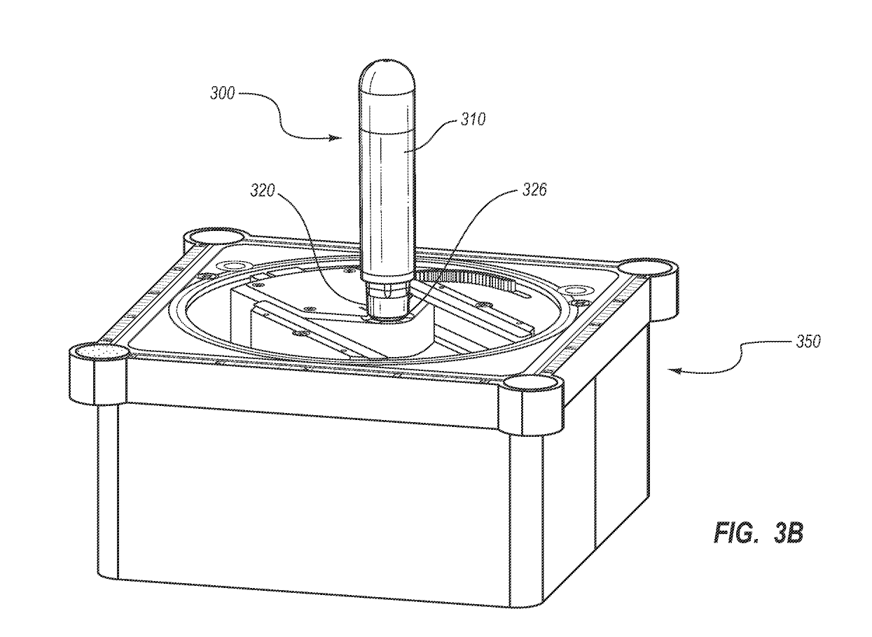

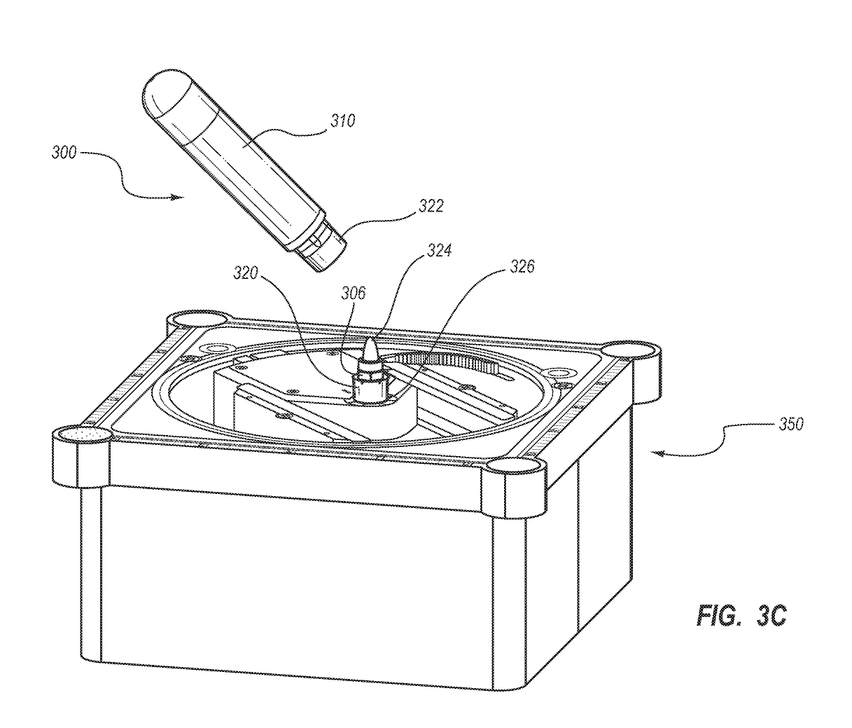

FIG. 3A depicts a tool 300 in which a cap has been removed, revealing a threaded connection member 325 of pattern creating implement 320. According to one embodiment, a female polygonal implement placement member on body 310 frictionally secures a polygonal male engagement member on pattern creating implement 320. A cutting tip, embossing tip, debossing tip, or other pattern creating implement has been removed from implement receptor 326 of pattern creating device 350. Utilizing body 310 of the tool, threaded connection member 325 may be rotationally threaded into implement receptor 326.

Pattern creating implement 320 may be adapted for any of a variety of pattern creating devices. Pattern creating device 350, according to the specific embodiment illustrated in FIG. 3A, includes an automatic plotter mechanism 375 with rotational, linear, and vertical movement. According to various embodiments, automatic plotter mechanism 375 may be adapted to manipulate pattern creating implement 320 to control the line width of a pattern using an asymmetric pattern creating tip (e.g., a fountain-tip pen).

FIG. 3B illustrates that connection member 325 is received by implement receptor. As illustrated in FIG. 3C, with connection member 325 received by implement receptor 326, engagement member 306 may be separated from implement placement member 322, by pulling body 310 away from pattern creating implement 320. With pattern creating implement 320 secured within implement receptor 326, pattern creating device 350 may be inverted and a pattern may be transferred to a media.

According to one embodiment, pattern creating device 350 includes an automated plotter mechanism with a graphical user interface allowing a user to select from a number of digital patterns, which are then transferred to a media, such as paper or cloth, via pattern creating tip 324. Accordingly, if pattern creating tip 324 is a marking tip, a pattern is drawn on the media in marker. Similarly, if pattern creating tip 324 is a glue tip, glue is placed on the media outlining or filling in a selected pattern. According to one embodiment, glitter or other embellishing material may be subsequently adhered to the glue pattern. In like manner, any number of decorating materials may be used in pattern creating tip 324 to transfer a pattern to a media. Pattern creating tip 324 may also be an embossing tip, debossing tip, a nozzle for dispensing a liquid, a cutter adapted to cut a specific media, or other suitable pattern creating tip. Additionally, pattern creating tip 324 may contain multiple colors of a specific decorative material or multiple decorative materials within a single pattern creating implement, automatically or manually selectable through a user interface of pattern creating device 350.

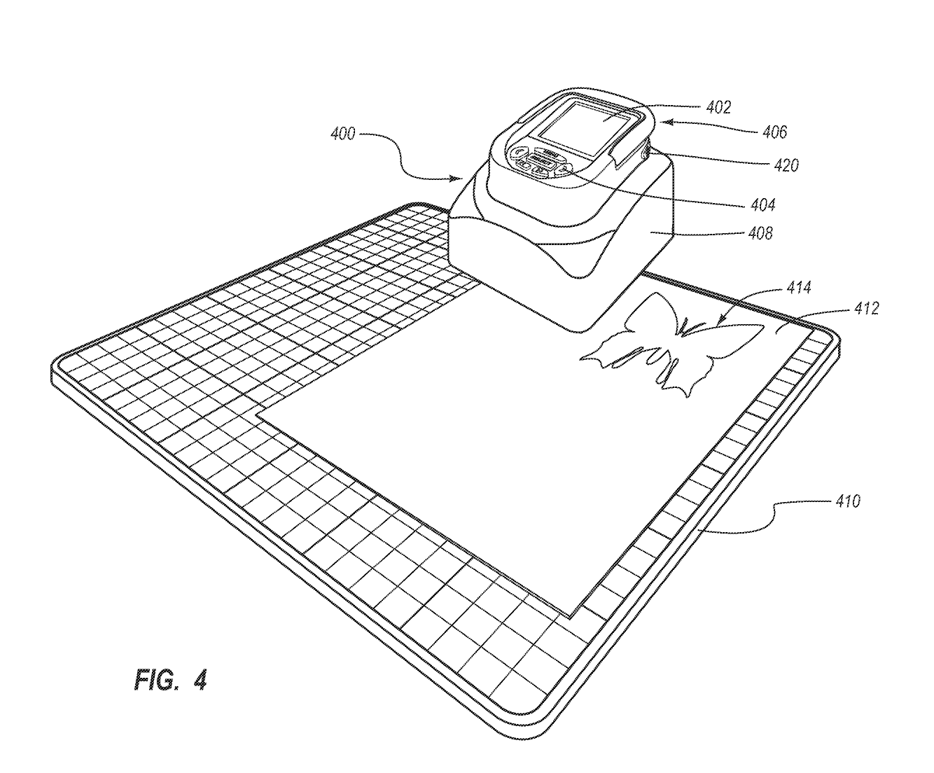

FIG. 4 illustrates an exemplary handheld pattern creating device 400 and an exemplary pattern of a butterfly 414 on a media 412 (as illustrated the media may be paper, metal, wood, or another sheet media). Butterfly 414 may be drawn in pen, pencil, chalk, glue, a liquid spray, paint, or any other suitable decorative material. Alternatively, the butterfly 414 may be a cut-out removable butterfly or embossed or debossed in the media. For example, according to one embodiment, the butterfly is drawn using a marking tip similar to pattern creating tip 324, illustrated in FIG. 3C. According to several embodiments, patterns are created on a media using a secondary mat 410. Secondary mat 410 may be configured as a multipurpose mat useful for a plurality of media, specifically adapted for a particular media, specifically adapted for a particular pattern creating implement, and/or may be adhesive.

Handheld pattern creating device 400 includes a digital or graphical user interface 402, inputs 404, a memory interface 406 (such as an SD card reader or universal serial bus (USB) port), a housing 408, and switch 420. Housing 408 provides a framework in which other components of handheld pattern creating device 400 are disposed. According to various embodiments, user interface 402 may include a color or black and white display, a touch screen, a wireless interface, or other the like. Graphical user interface 402 allows a user to select from among a variety of different options. For example, user interface 402 may allow a user to select from a library of clip-art patterns, including butterfly 414, letters of varying fonts, sizes, and languages, etc. Memory interface 406 may allow a user to insert images which may be selected by the user in creating a pattern of a desired image. Buttons 404 and switch 420 allow a user to provide additional input to control the mechanism and may include a power button, digital control mechanisms, or other functionality associated with handheld pattern creating device 400.

According to various embodiments, pattern creating device 400 is manually secured relative to media 412. Alternatively, pattern creating device 400 is configured for hands-free use. For example, pattern creating device 400 may utilize magnets, levers, clamps, suction cups, locks, or a combination thereof to secure pattern creating device 400 relative to media 412 and/or secondary mat 410.

According to various embodiments, when a user wishes to switch colors or decorative materials, the user removes a pattern creating implement and replaces it with a different pattern creating implement. According to various embodiments, additional pattern creating implements may be stand-alone units or may be a part of a tool.

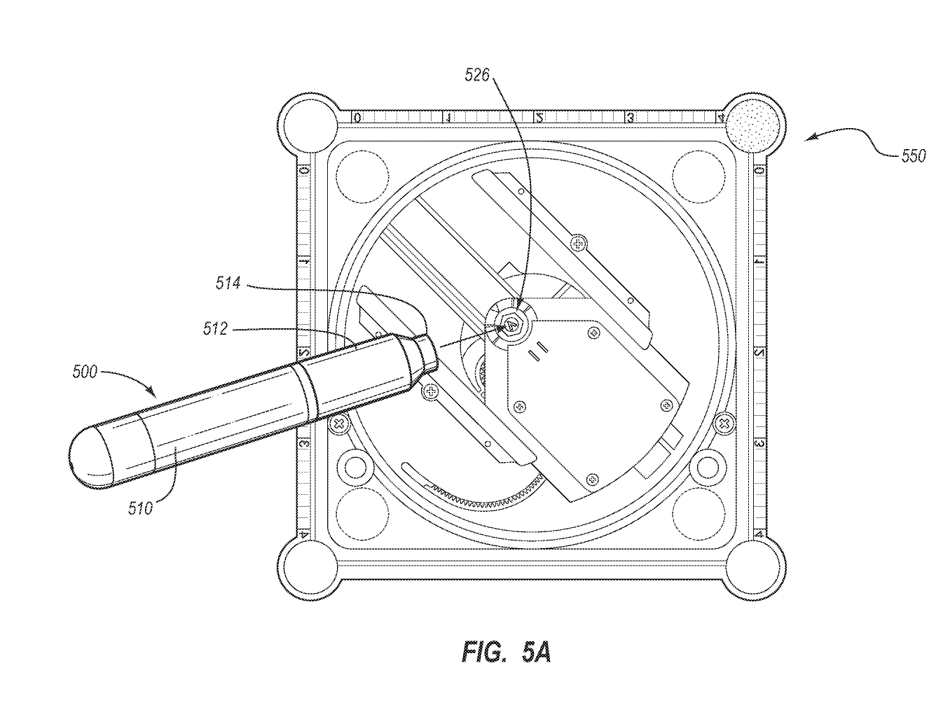

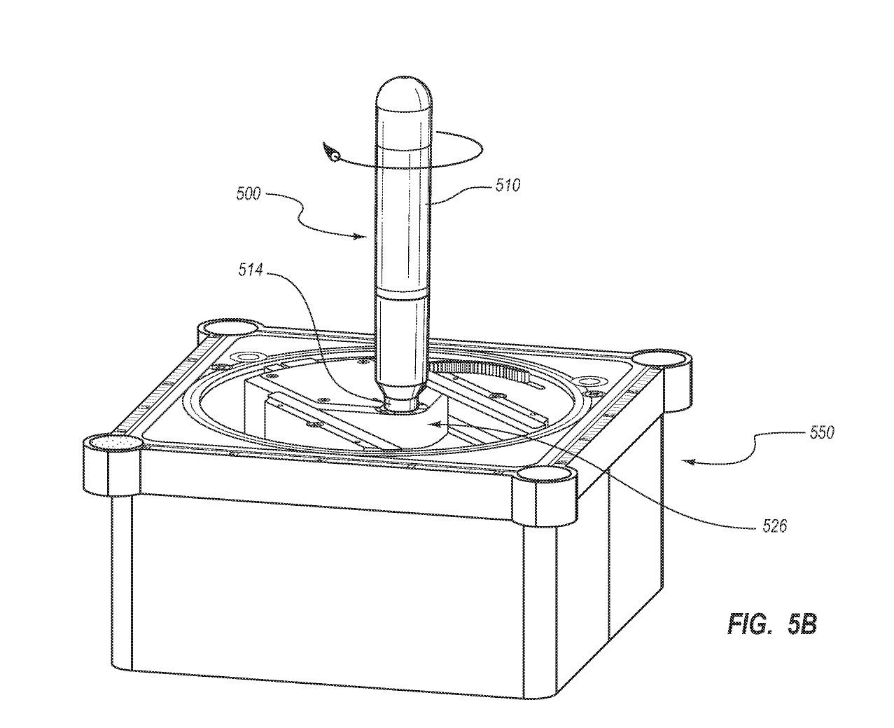

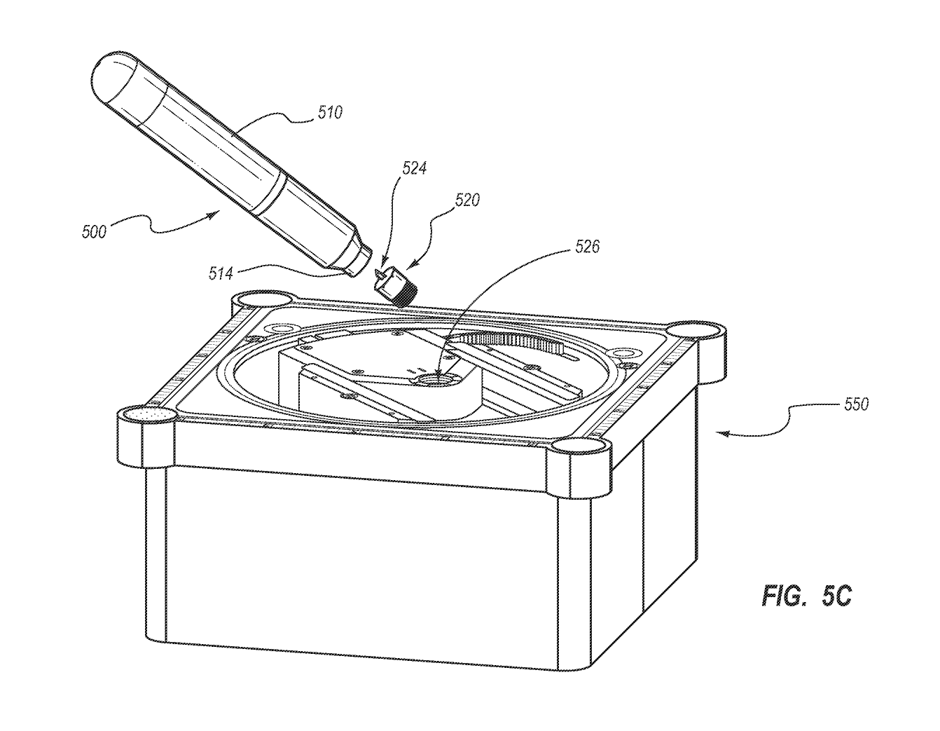

FIG. 5A illustrates a cap 512 of a tool 500, which includes an implement removal tool 514. Implement removal tool 514 is adapted to mate with an engagement member (not shown) on a pattern creating implement (not shown) and may be used for removing the pattern creating implement from implement receptor 526 of pattern creating device 550. As previously described, implement removal tool 514 may include a shape that is complementary to the engagement member of a pattern creating implement.

Body 510 may be used to grasp implement removal tool 514 during the removal of a pattern creating implement, as illustrated in FIG. 5B. As discussed above, the pattern creating implement may include a threaded connection member for mating with threaded implement receptor 526 of pattern creating device 550. According to alternative embodiments, a connection member and an implement receptor may include any of a wide variety of connection members, including a threaded connection member, a twist lock connection member, a snap-on connection member, a taper member, a friction-fit connection member, and combinations thereof. In an embodiment including a threaded connection member, handle 510 may be use to rotate implement removal tool 514 during the insertion or removal process in order to remove a pattern creating implement.

FIG. 5C illustrates a pattern creating implement 520 following its removal from implement receptor 526. According to the illustrated embodiment, pattern creating implement 520 includes a cutting tip 524; however, any of a wide variety of pattern creating implements may be removed in a similar manner. Pattern creating implement 520 typically remains connected to insert removal tool 514 during the removal of pattern creating implement 520 from implement receptor 526.

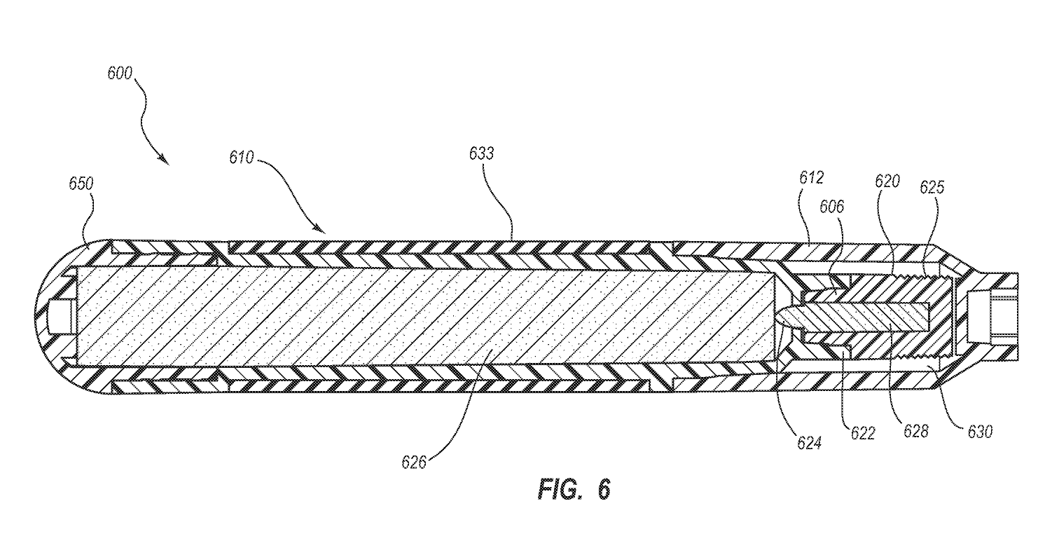

As described above, according to various embodiments, pattern creating implements may include a marking decorative material that is resupplied when a pattern creating tip is inserted into a body of a tool containing a reservoir of decorating material. An example of such a tool 600 is illustrated in FIG. 6. As illustrated, a body 610 of tool 600 includes a reservoir 626 and an end cap 650. End cap 650 allows reservoir 626 to be filled and/or refilled with a suitable decorating material. Pattern marking tip 624 contacts reservoir 626 and is thereby refilled. According to various alternative embodiments, the contact between reservoir 626 and pattern creating tip 624 may be adapted to suit the particular pattern creating tip and/or the decorating material.

Additionally, a tip supply well 628 is depicted within pattern creating implement 620, such that a decorating material reservoir may be stored in pattern creating implement. In an embodiment where pattern marking tip 624 comprises a marker tip, capillary action or other absorption mechanisms draw decorative material from reservoir 626 through pattern creating tip 624 and into tip supply well 628. According to one embodiment, a sufficient supply of decorating material is stored within pattern creating implement 620 to allow for continued use of pattern creating implement 620 during the course of a pattern transfer. In this manner, continual removal and replacement of pattern creating implement 620 to resupply marker decorative material is not required.

According to various embodiments, body 610 may include a rubberized grip 633. Rubberized grip 633 may be disposed in a recessed portion of body 610 such that the outer profile of body 610 remains even, as illustrated in FIG. 6. Alternatively, a grip, rubberized or other, may be disposed on an outer perimeter of body 610. Any number of types of grip 633 or other frictional components may be adapted for use with tool 600 and may or may not result in body 610 having an even profile.

In the illustrated embodiment, cap 612 is adapted to secure pattern creating implement 620 relative to body 610 during storage of tool 600. Cap 612 may be adapted to couple to body 610 and form a recess 630, which may accommodate pattern creating implement 620. According to one embodiment, cap 612 contacts connection member 625 to ensure that pattern creating tip 624 remains in contact with reservoir 626. According to the illustrated embodiment, pattern creating implement 620 does not contact the sidewalls of cap 612, leaving recess 630 partially empty. Alternatively, recess 630 is adapted to completely or nearly completely encompass pattern creating implement 620.

When a user desires to install pattern creating implement 620 in a pattern creating device the user removes cap 612 exposing connection member 625 (illustrated as a threaded connection member). A user may then utilize body 610 through implement placement tool 622 and engage engagement member 606 to threadably insert connection member 625 into an implement receptor of a pattern creating device. Once pattern creating implement 620 has been coupled to a pattern creating device (not shown), a user withdraws body 610 to separate body 610 from pattern creating implement 620.

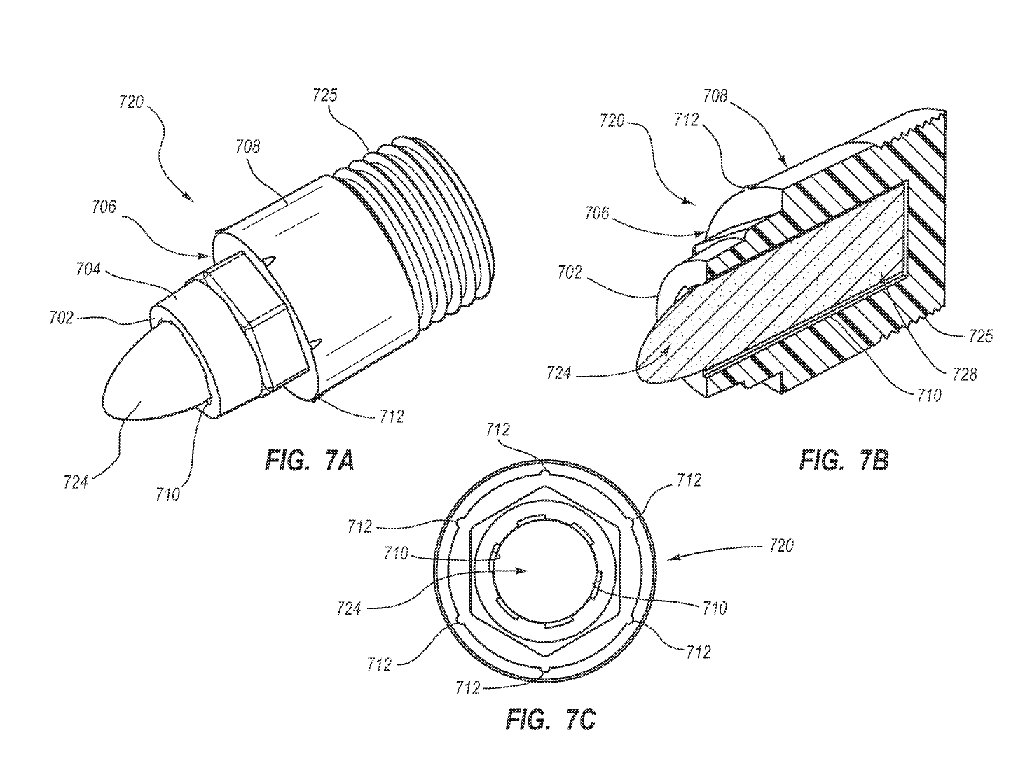

FIG. 7A provides a perspective view of a pattern creating implement 720, according to one exemplary embodiment, in which a pattern creating tip 724 is a marking tip. As illustrated, pattern creating implement 720 includes pattern creating tip 724, a supporting cylindrical member 704, an engagement member 706, a body portion 708, and a connection member 725 (illustrated as a threaded connection member). In the illustrated embodiment, a plurality of vent channels 710 are disposed around the outer circumference of pattern creating tip 724 within the supporting cylindrical member 704. Vent channels 710 may control or enable the flow of a decorating material from pattern creating tip 724 to a media.

As illustrated engagement member 706 is a hexagonal engagement surface; however, according to various alternative embodiments engagement member 706 may comprise any of a wide variety of engageable surfaces. For example, engagement member 706 may include a polygonal surface having any number of sides, protrusions, intrusions, friction fittings, tapers, or combinations thereof. According to various embodiments, engagement surface 706 is configured to be engaged by an implement placement member disposed on an end of a body of a tool and/or by an implement removal tool disposed on an end of a cap of a tool. Body portion 708 is positioned between the connection member 725 and engagement member 706. According to one embodiment, body portion 708 is substantially cylindrical in nature and has a larger circumferential cross-section than the other components of pattern creating implement 720. Alternatively, body portion 708 may be of any shape or size suitable to joint connection member 725 to engagement member 706. According to one embodiment, body portion 708 is not included as a component of pattern creating implement 720, such that connection member 725 is directly connected to engagement member 706.

FIG. 7B provides a cross-sectional view of pattern creating implement 720. As illustrated pattern creating tip 724 may include a tip supply well 728. Vent channels 710 may extend along at least portions of the length of tip supply well 728. According to one embodiment, a plurality of protrusions 712 are provided in connection with body portion 708. Protrusions 712 may be configured to frictionally engage a portion of an implement placement member of a pattern creating implement.

FIG. 7C illustrates a top view of pattern creating implement 720 as seen from the pattern creating tip 724. As illustrated, pattern creating implement 720 includes a pattern creating tip 724 with vent channels 710 configured to facilitate airflow.

As illustrated, pattern creating implement 720 includes a marker tip for dispensing a decorative material; however, as previously described, pattern creating implement 720 may be adapted to dispense a wide variety of decorative materials, cut, deboss, emboss, dispense a fluid through a nozzle, or otherwise create a pattern. Examples of mediums that may be dispensed from or applied via a pattern creating implement include marker, glue, liquids, paint, glitter, icing, chalk, ink, graphite, lead, and any other embellishing or decorative material, which may be applied or dispensed.

Moreover, while the illustrated embodiments include a threaded connection member 725, any of a wide variety of connection members may be used, including threads, twist lock members, grooves, protrusions, snap-on elements, friction-fit components, or other suitable connection elements and combinations thereof.

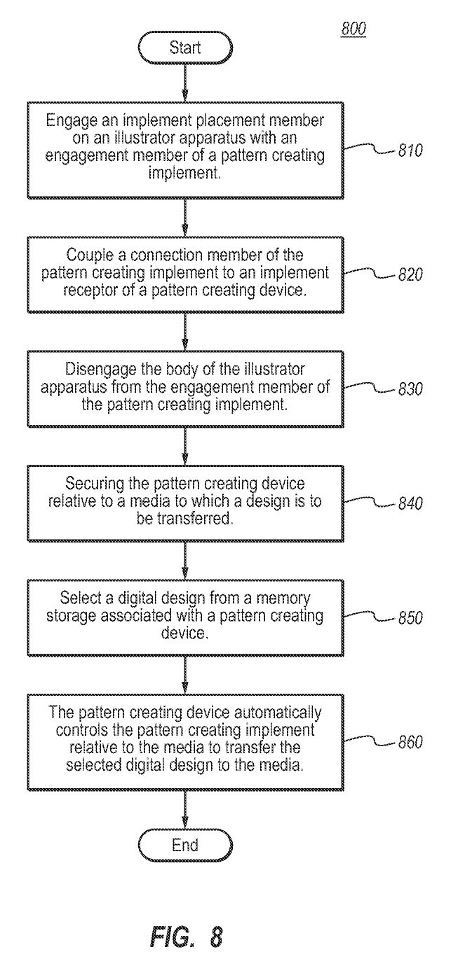

FIG. 8 illustrates a method 800 of transferring a digital image from a pattern creating device to a media. According to one embodiment, at 810, an implement placement member disposed on an end of a body of a tool engages an engagement member of a pattern creating implement. A connection member disposed on an end of the pattern creating implement may be coupled to an implement receptor of a pattern creating device, at 820. For example, a body may provide leverage to rotateably couple a threaded connection member of a pattern creating implement into a threaded implement receptor of a pattern creating device.

At 830, a user may disengage the body of the tool from the engagement member of the pattern creating implement. At 840, according to one embodiment, the pattern creating device is manually secured relative to a media to which a pattern is to be transferred. Alternatively, the pattern creating device may include a self-securing component, such as a magnetic member, configured to self-secure the pattern creating device relative to a media. A user may then, if not previously done, select a digital pattern from a memory storage associated with the pattern creating device, at 850. At 860, the pattern creating device moves the pattern creating implement relative to the media in order to transfer the selected digital pattern to the media. According to various embodiments, the pattern creating device controls rotational movements of the pattern creating implement as well as movements in any number of directions in three-dimensional space. In this manner, a digital image may be transferred from a pattern creating device to a media. As previously described, a user may select a pattern creating device having a specific pattern creating tip so as to create the pattern in a desired decorative material and color. Alternatively, a cutter, debosser, embosser, or other pattern creating implement may be chosen.

The above description provides numerous specific details for a thorough understanding of the embodiments described herein. One or more of the specific details may be omitted, or other methods, components, or materials may be used. In some cases, operations are not shown or described in detail.

While specific embodiments and applications of the disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure

What is claimed is:

1. A tool comprising:
a body, comprising:
an implement placement member;
a pattern creating implement comprising:
a first end;
a second end;
an engagement member disposed between the first end and the second end of the pattern creating implement;
a pattern creating tip disposed on the first end of the pattern creating implement; and
a connection member disposed on the second end of the pattern creating implement configured to secure the pattern creating implement to an implement receptor of a pattern creating device;
wherein the implement placement member of the body is configured to detachably engage the engagement member of the pattern creating implement, so as to position the pattern creating tip within the first end of the body.

2. The tool of claim 1, further comprising a cap having a first end and a second end, the first end configured to detachably couple the cap to the first end of the body, such that the connection member of the pattern creating implement is enclosed within the cap.

3. The tool of claim 2, wherein the cap further comprises an implement removal tool disposed on the exterior of the second end of the cap, the implement removal tool configured to engage the engagement member of the pattern creating implement in order to remove the pattern creating implement from the implement receptor of the pattern creating device.

4. The tool of claim 1, wherein the pattern creating tip comprises one of a marking tip, cutting tip, gluing tip, embossing tip, and a debossing tip.

5. The tool of claim 1, wherein the connection member comprises one of a threaded connection member, a twist lock connection member, a snap-on connection member, and a friction-fit connection member.

6. The tool of claim 1, wherein the pattern creating tip comprises a fluid dispensing tip and the body houses a fluid reservoir, such that when the pattern creating tip is positioned within the first end of the body, fluid from the fluid reservoir is transferred from the reservoir to the pattern creating tip.

7. The tool of claim 1, wherein the implement placement member is configured to engage the engagement member of the pattern creating implement and detachably couple the connection member of the pattern creating implement to an implement receptor of a pattern creating device.

8. The tool of claim 1, wherein the pattern creating tip comprises a spray nozzle configured to selectively dispense a fluid.

9. The tool of claim 8, wherein the fluid is one of a decorative icing and a paint.

10. A pattern creating system comprising:
a pattern creating device comprising:
a memory storage for storing one or more digital patterns;
an implement receptor configured to detachably secure a pattern creating implement used to transfer a digital pattern to a desired media;
a drive mechanism configured to control the movement of the implement receptor based on a selected digital pattern stored in the memory storage;
a housing for securing one or more of the memory storage, the pattern creating implement, and the drive mechanism;
the tool comprising:
a body including an implement placement member disposed on a first end thereof;
a pattern creating implement comprising:
an engagement member disposed between a first and a second end of the pattern creating implement,
a pattern creating tip disposed on the first end of the pattern creating implement, and
a connection member disposed on the second end of the pattern creating implement configured to secure the pattern creating implement to the implement receptor of the pattern creating device;
wherein the implement placement member of the body is configured to detachably engage the engagement member of the pattern creating implement, so as to position the pattern creating tip within the first end of the body.

11. The pattern creating system of claim 10, further comprising a graphical user interface for selecting a digital pattern stored in the memory storage.

12. The pattern creating system of claim 10, further comprising a cap having a first end and a second end, the first end configured to detachably couple the cap to the first end of the body, such that the connection member of the pattern creating implement is enclosed within the cap.

13. The pattern creating system of claim 12, wherein the cap further comprises an implement removal tool disposed on the exterior of the second end of the cap, the implement removal tool configured to engage the engagement member of the pattern creating implement in order to remove the pattern creating implement from the implement receptor of the pattern creating device.

14. A method of transferring a digital pattern to a media comprising:
engaging an implement placement member disposed on a first end of a body of a tool with an engagement member disposed on a first end of a pattern creating implement;
detachably coupling a connection member disposed on the second end of a pattern creating implement to an implement receptor of a pattern creating device;
disengaging the body of the tool from the engagement member of the pattern creating implement;
securing the pattern creating device relative to a media to which a pattern is to be transferred.

15. The method of claim 14, further comprising:
selecting a digital pattern from a memory storage associated with the pattern creating device;
the pattern creating device moving the pattern creating implement relative to the media to which the pattern is to be transferred based on the selected digital pattern, such that the selected digital pattern is transferred, via the pattern creating implement, to the media.

16. The method of claim 15, further comprising a graphical user interface for selecting the digital pattern from the memory storage.

17. The method of claim 14, further comprising removing a cap from the body of the pattern creating implement to expose the connection member of the pattern creating implement prior to detachably coupling the connection member of the pattern creating implement to the implement receptor of the pattern creating device.

18. The method of claim 14, further comprising, after the pattern has been transferred to the media:
removing the pattern creating implement from the pattern creating device by decoupling the connection member from the implement receptor;
returning the pattern creating tip to the body of the tool by engaging the engagement member of the pattern creating implement with the implement placement member.

19. A pattern creating implement comprising:
a first end and a second end;
a pattern creating tip disposed on the first end;
a connection member disposed on the second end; and
an engagement member disposed between the first end and the second end configured to be engaged by an implement placement member for detachably coupling the connection member to an implement receptor of a pattern creating device.

20. The pattern creating implement of claim 19, wherein the pattern creating tip comprises one of a marking tip, cutting tip, gluing tip, embossing tip, and a debossing tip.

21. The pattern creating implement of claim 19, wherein the pattern creating tip comprises a spray nozzle configured to selectively dispense a fluid.

22. The pattern creating implement of claim 21, wherein the fluid is one of a decorative icing and a paint.

23. The pattern creating implement of claim 19, wherein the connection member comprises one of a threaded connection member, a twist lock connection member, a snap-on connection member, and a friction-fit connection member.

24. The pattern creating implement of claim 19, wherein the pattern creating tip comprises a fluid dispensing tip and is configured to be inserted at least partially into a body, the body housing a fluid reservoir, such that when the pattern creating tip is positioned within the first end of the body, fluid from the fluid reservoir is transferred from the reservoir to the pattern creating tip.
